(19) United States
(12) Patent Application Publication
(10) Pub. No.: US 2026/0241534 A1
(43) Pub. Date: Aug. 20, 2026

(54) USAGE STATUS MANAGEMENT APPARATUS FOR ELECTRIC GRIPPING TOOL AND USAGE STATUS MANAGEMENT SYSTEM PROVIDED WITH SAME

(71) Applicant: OMRON CORPORATION, Kyoto-shi, Kyoto (JP)

(72) Inventors: Ryoji OKAZAKI, Kyoto-shi (JP); Eiji YASUDA, Ichinomiya-shi (JP); Shinya GOSHIMA, Ichinomiya-shi (JP)

(73) Assignee: OMRON CORPORATION, Kyoto-shi, Kyoto (JP)

(21) Appl. No.: 19/160,514

(22) PCT Filed: Feb. 16, 2024
(86) PCT No.: PCT/JP2024/005441

§ 371 Date: Aug. 28, 2025

(30) Foreign Application Priority Data
Mar. 3, 2023 (JP) 2023-033044

(51) Int. Cl. B25F 5/02

(52) U.S. Cl. CPC B25F 5/026

(57) ABSTRACT

A manager terminal of an electric gripping tool is a usage status management apparatus that manages the usage status of the electric gripping tool, and includes a communication unit and a storage unit. The communication unit acquires, from the electric gripping tool, information related to the work duration and safe operation status of each user, as information related to the usage status of the electric gripping tool. The storage unit stores information related to the usage status acquired by the communication unit.

### TECHNICAL FIELD

The present invention relates to a usage status management apparatus for electric gripping tools, such as electric screwdrivers, grinders, jigsaws, and chainsaws, which use electric power to drive a tool bit to perform various operations, as well as a usage status management system equipped with the same.

### BACKGROUND ART

Electric gripping tools, in which a tool bit such as a drill or a driver is rotationally driven by a motor to perform a desired task, are widely used at worksites and factories (see Patent Literature 1, for example).

Electric gripping tools such as these include those that have an auxiliary handle mounted to the main body so that the user can use the electric gripping tool in a more stable state.

For instance, Patent Literature 1 discloses an electric tool that comprises an output shaft that protrudes forward from a gear case in which a gear is housed and that is rotated by the rotational force of a motor when a tool bit is attached, in order to improve convenience when an auxiliary handle is used; a receiving device that receives a signal from an inertial sensor provided to the auxiliary handle when the auxiliary handle is attached; and a controller that outputs a control signal that controls the rotation of the output shaft on the basis of the signal from the inertial sensor.

### CITATION LIST

### Patent Literature

Patent Literature 1: JP-A 2021-151692

Patent Literature 2: JP-A 2012-096299

### SUMMARY

### Technical Problem

However, the following problem is encountered with the above-mentioned conventional power tools.

With the power tools disclosed in the above publications, whether or not the handle part is being gripped by the operator is determined on the basis of the distance between the handle and the operator's hand, and when it is estimated that the operator is touching the handle, the rotation of the output shaft is permitted, so it is difficult to determine whether or not the operator is gripping the handle firmly. Therefore, even though the operator is working in a state of not gripping the handle firmly, rotation of the output shaft may end up being permitted, which poses the risk that the safety of the operator may not be sufficiently ensured in the event that the power tool is subjected to a large reaction force.

It is an object of the present invention to provide an electric gripping tool usage status management apparatus that can properly manage whether an electric gripping tool is being used safely and properly, as well as a usage status management system equipped with this apparatus.

### Solution to Problem

The electric gripping tool usage status management apparatus according to the first invention is a usage status management apparatus that manages the usage status of an electric gripping tool, comprising a usage status acquisition unit and a storage unit. The usage status acquisition unit acquires, from the electric gripping tool, the work duration and the safe operation status of each user, as information related to the usage status of the electric gripping tool. The storage unit stores the information related to the usage status acquired by the usage status acquisition unit.

Here, in order to manage whether the user of an electric gripping tool is using it safely and properly, communication is performed with the electric gripping tool, and the work duration of each user and safe operation status for each user is acquired and stored as information related to the usage status of the electric gripping tool.

An example of a usage status management apparatus is a terminal device such as a personal computer (PC) that is installed at a management company or the like that manages users who perform work using electric gripping tools.

This allows the usage status management apparatus to acquire and manage information related to each user's work duration and whether the device is being operated safely, making it possible to take measures such as sending a message to the user urging him to stop working or to operate safely.

As a result, it is possible to appropriately manage whether the electric gripping tool is being used safely and properly.

The electric gripping tool usage status management apparatus of the second invention is the electric gripping tool usage status management apparatus of the first invention, wherein the electric gripping tool is used in a state in which an auxiliary handle has been mounted, and the usage status includes the result of detecting a user's gripped state of the auxiliary handle and the input of a specific operation.

Consequently, when the electric gripping tool is used with the auxiliary handle attached, it can be determined that the tool is being operated safely if two conditions are met: the auxiliary handle is being gripped and a specific operation is inputted.

The electric gripping tool usage status management apparatus according to the third invention is the electric gripping tool usage status management apparatus according to the second invention, wherein the specific operation includes an operation of rotating a grip portion of the auxiliary handle.

Consequently, if it is detected that the user has not only touched the auxiliary handle but also rotated the grip portion of the auxiliary handle, the drive unit is permitted to be driven, making it possible to manage a state in which it is presumed that the operator is firmly gripping the auxiliary handle and working safely.

The electric gripping tool usage status management apparatus according to the fourth invention is the electric gripping tool usage status management apparatus according to the second invention, wherein the specific operation includes an operation of pressing a lever portion provided to the auxiliary handle.

Consequently, if it is detected that the user has not only touched the auxiliary handle but also pressed the lever portion of the auxiliary handle, operation of the drive unit is permitted, thereby making it possible to manage a state in which it is presumed that the operator is firmly gripping the auxiliary handle and working safely.

The electric gripping tool usage status management apparatus according to the fifth invention is the electric gripping tool usage status management apparatus according to the second invention, wherein the specific operation includes an operation of pressing a button portion provided to the auxiliary handle.

Consequently, if it is detected that the user has not only touched the auxiliary handle but also pressed the button portion of the auxiliary handle, operation of the drive unit is permitted, thereby making it possible to manage a state in which it is presumed that the operator is firmly gripping the auxiliary handle and working safely.

The electric gripping tool usage status management apparatus of the sixth invention is the electric gripping tool usage status management apparatus of the first or second invention, wherein the usage status acquisition unit communicates with an operator terminal owned by each user of the electric gripping tool.

Consequently, a system can be configured to include an operator terminal that communicates between a power tool and the usage status management apparatus, so that when a situation is detected in which the electric gripping tool is not being used safely, for example, a message urging the operator to use it safely can be sent to the operator terminal.

The electric gripping tool usage status management apparatus according to the seventh invention is the electric gripping tool usage status management apparatus according to the first or second invention, wherein the usage status includes a determination result related to whether or not the electric gripping tool can be used, as determined in the electric gripping tool.

Consequently, a determination result indicating whether or not the electric gripping tool can be used, depending on whether or not the user is using the tool safely, is received from the electric gripping tool, thereby preventing an operator who is presumed not to be using the tool safely from being allowed to perform work.

The electric gripping tool usage status management apparatus of the eighth invention is the electric gripping tool usage status management apparatus of the first or second invention, wherein the usage status includes unique ID information assigned to each electric gripping tool.

Consequently, a unique ID (identification) assigned to each electric gripping tool is received as the usage status, making it possible to manage the ID of the electric gripping tool in association with the usage status of each operator.

The electric gripping tool usage status management apparatus according to the ninth invention is the electric gripping tool usage status management apparatus according to the second invention, wherein the usage status includes unique ID information assigned to each auxiliary handle.

Consequently, the unique ID (identification) assigned to the auxiliary handle attached to the electric gripping tool is received as the usage status, making it possible to manage the ID of the auxiliary handle in association with the usage status of each operator.

The electric gripping tool usage status management apparatus according to the tenth invention is the electric gripping tool usage status management apparatus according to the sixth invention, wherein the usage status includes unique ID information assigned to each of the operator terminals.

Consequently, the unique ID (identification) assigned to each operator's terminal, such as a smartphone or tablet terminal owned by each operator, is received as the usage status, making it possible to manage the ID of the operator's terminal in association with the usage status of each operator.

The electric gripping tool usage status management apparatus of the eleventh invention is the electric gripping tool usage status management apparatus of the first or second invention, further comprising a display unit that displays the usage status of the electric gripping tool for each user, which is stored in the storage unit.

Consequently, the usage status of each user of the electric gripping tool is displayed on the display unit, so a manager who manages the user of the electric gripping tool can easily ascertain the usage status of each user and take appropriate measures, such as encouraging improvement.

The electric gripping tool usage status management apparatus according to the twelfth invention is the electric gripping tool usage status management apparatus according to the second invention, wherein the usage status acquisition unit communicates with a communication unit provided to the auxiliary handle.

Consequently, a system can be configured to include an electric gripping tool that is used with an auxiliary handle attached, and mutual communication can be carried out between the usage status management apparatus, the electric gripping tool, and the auxiliary handle, making it possible to easily manage the usage status of each user.

The electric gripping tool usage status management system according to the thirteenth invention comprises the electric gripping tool usage status management apparatus according to the first or second invention, and an electric gripping tool.

Consequently, in an electric gripping tool usage status management system, information related to each user's work duration and whether the tool is being safely operated can be acquired and managed, making it possible to take measures such as a sending message to a user urging him to stop working or to operate safely.

As a result, it is possible to properly manage whether an electric gripping tool is being used safely and properly.

### Advantageous Effects

With the electric gripping tool usage status management apparatus of the present invention, whether or not an electric gripping tool is being used safely and properly can be appropriately managed.

### BRIEF DESCRIPTION OF DRAWINGS

FIG. 1 is an oblique view of the configuration of an electric gripping tool included in a usage status management system according to an embodiment of the present invention;

FIG. 2 is an oblique view of the state when an auxiliary handle is attached to the main body of the electric gripping tool in FIG. 1;

FIG. 3 is a control block diagram showing the configuration of a usage status management system including a manager terminal of an electric gripping tool according to an embodiment of the present invention;

FIG. 4 is an oblique view of the configuration of the auxiliary handle in FIG. 2;

FIG. 5A is a front view of the auxiliary handle in FIG. 4, and FIG. 5B is a cross-sectional view along the A-A line in FIG. 5A;

FIG. 6A is a side view of the auxiliary handle in FIG. 4, and FIG. 6B is a cross-sectional view along the B-B line in FIG. 6A;

FIG. 7 is an exploded oblique view of the components constituting the auxiliary handle in FIG. 4;

FIG. 8 is a diagram of a table that includes information such as the safe operation status, work duration, and whether or not work can be continued for each operator, which is managed at a manager terminal that communicates with the electric gripping tool in FIG. 3;

FIG. 9 is a flowchart showing the flow of processing in a control method for the electric gripping tool in FIG. 1;

FIG. 10 is a flowchart showing the flow of processing in a control method for the electric gripping tool in FIG. 1;

FIG. 11 is a diagram of the configuration of an electric gripping tool including an auxiliary handle according to Embodiment 2 of the present invention;

FIG. 12 is an oblique view of the configuration of the auxiliary handle and the mounting portion on the main body side in FIG. 11;

FIG. 13 is an exploded oblique view of the components constituting the auxiliary handle in FIG. 11;

FIG. 14 is a diagram of the configuration of an electric gripping tool including an auxiliary handle according to Embodiment 3 of the present invention;

FIG. 15 is an oblique view of the configuration of the auxiliary handle and the mounting portion on the main body side in FIG. 14;

FIG. 16 is an exploded oblique view of the components constituting the auxiliary handle in FIG. 14; and

FIG. 17 is a control block diagram showing the configuration of a usage status management system that includes a manager terminal for an electric gripping tool according to Embodiment 4 of the present invention.

### DESCRIPTION OF EMBODIMENTS

### Embodiment 1

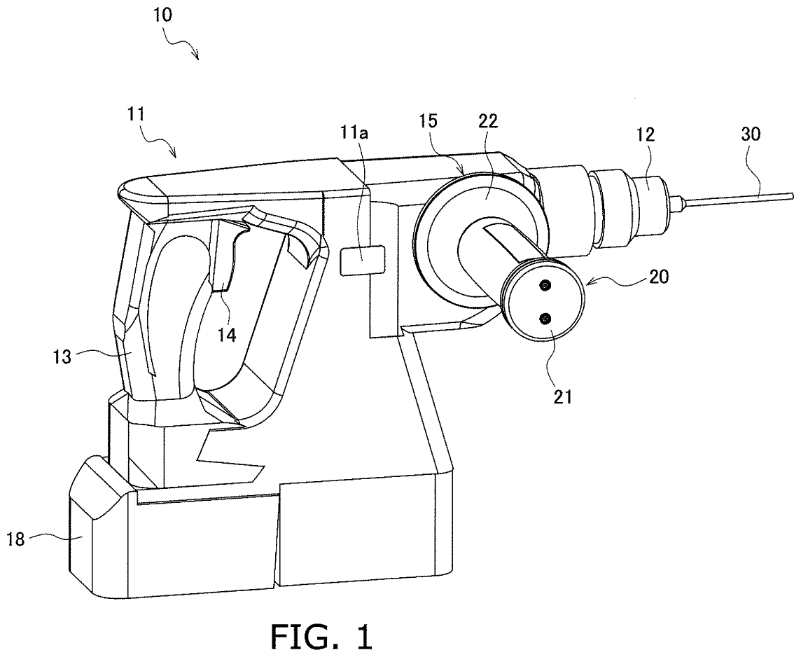

The usage status management apparatus (manager terminal 50) for an electric gripping tool 10 according to an embodiment of the present invention, and a usage status management system 1 including this apparatus, will now be described with reference to FIGS. 1 to 10.

In this embodiment, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### (1) Configuration of Usage Status Management System 1 for Electric Gripping Tool

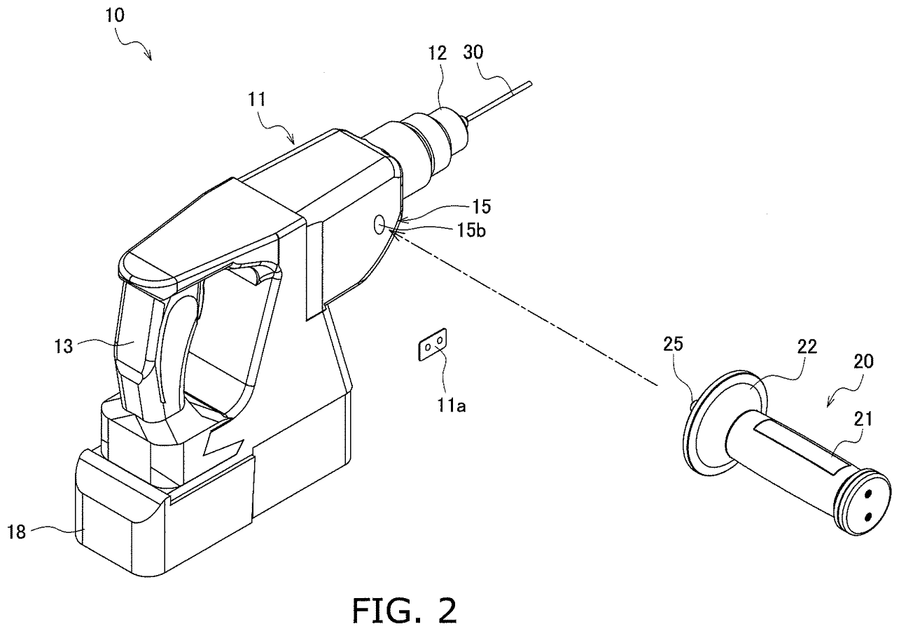

The usage status management system 1 for the electric gripping tool 10 in this embodiment is capable of communication between the electric gripping tool 10 shown in FIGS. 1 and 2, an operator's smartphone (operator terminal) 40, and a manager terminal (usage management apparatus) 50, and information related to the usage status of the electric gripping tool 10 is transmitted from the electric gripping tool 10 to the manager terminal 50.

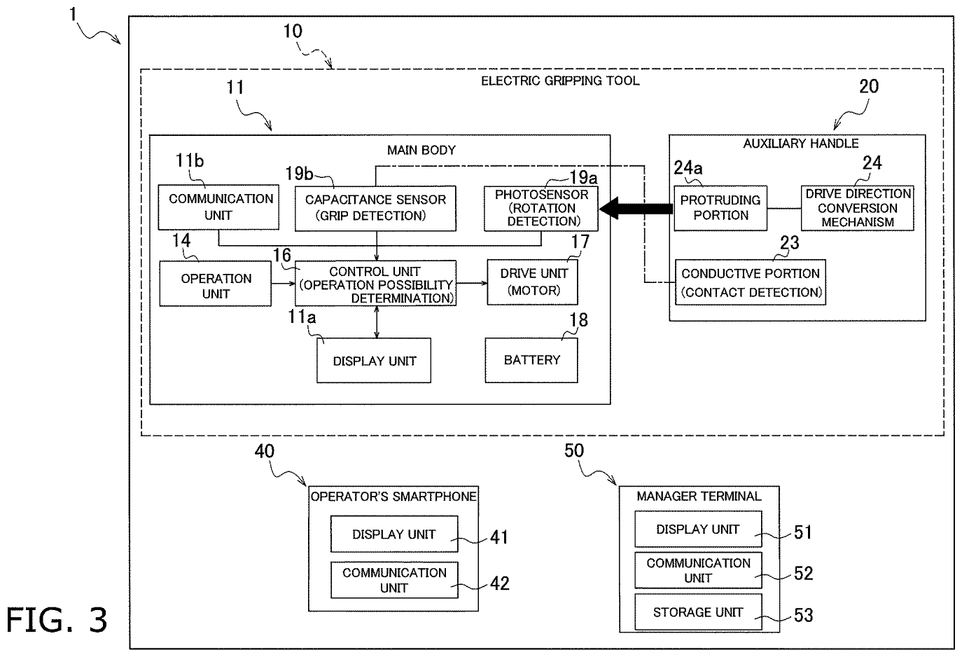

As shown in FIG. 3, the usage status management system 1 includes the electric gripping tool 10, the operator's smartphone 40, and the manager terminal (usage status management apparatus) 50.

As shown in FIG. 1, the electric gripping tool 10 is used for a variety of tasks, such as tightening screws, loosening screws, and drilling holes, by rotating a tool bit 30, such as a screwdriver or drill bit, that is attached to the distal end portion of the electric gripping tool 10, by means of a brushless motor (drive unit 17) powered by a battery 18.

The operator's smartphone 40 is, for example, a terminal device such as a smartphone or tablet terminal owned by each user of the electric gripping tool 10, and has a display unit 41 and a communication unit 42 as shown in FIG. 3.

The display unit 41 is, for example, an LCD display panel or an organic EL display panel of a smartphone, tablet terminal, or the like, and displays information related to safe usage status transmitted from the electric gripping tool 10, information related to the usage status of each user of the electric gripping tool 10 transmitted from the manager terminal 50, etc.

The communication unit 42 communicates with the communication unit 52 of the manager terminal 50, and receives information related to the usage status and usability of the electric gripping tool 10, messages prompting safe operation, and so forth. The communication unit 42 also communicates with the communication unit 11b of the electric gripping tool 10, and receives, for example, information related to the usage status from the electric gripping tool 10.

The manager terminal (usage status management apparatus) 50 communicates with the electric gripping tool 10, acquires information related to the usage status of the electric gripping tool 10, and manages whether work is being performed safely for each user of the electric gripping tool 10. As shown in FIG. 3, the manager terminal 50 has a display unit 51, the communication unit (usage status acquisition unit) 52, and a storage unit 53.

The display unit 51 is, for example, a monitor of a PC (personal computer) installed at a management company or the like that manages users who perform work with an electric gripping tool, and displays information related to the safe usage status transmitted from the electric gripping tool 10, information related to the usage status of each user of the electric gripping tool 10 (safe operation status, work duration, etc.), and so forth.

The communication unit (usage status acquisition unit) 52 communicates with the communication unit 42 of the operator's smartphone 40, and receives an ID unique to each operator's smartphone 40, etc. The communication unit 52 also communicates with the communication unit 11b of the electric gripping tool 10, and receives from the electric gripping tool 10, for example, information related to the usage status and a determination result on whether or not the electric gripping tool 10 can be used.

The storage unit 53 stores information received via the communication unit 52, such as a unique ID (identification) assigned to each operator's smartphone 40 owned by each user, a unique ID assigned to each electric gripping tool 10, a unique ID assigned to each auxiliary handle 20, information related to the usage status of the electric gripping tool 10, and a determination result regarding whether or not the tool can be used.

### (2) Configuration of Electric Gripping Tool 10

As shown in FIGS. 1 and 2, the electric gripping tool 10 includes a main body 11 and an auxiliary handle 20 that is removably attached to the main body 11.

### (2-1) Configuration of Main Body 11

As shown in FIGS. 1 and 2, the main body 11 is equipped with a drive unit 17 that is driven by power supplied by a battery 18 that is removably attached to the lower part, and various tasks are performed by replacing various tool bits 30 that are removably attached to the distal end portion.

As shown in FIGS. 1 and 2, the main body 11 includes a display unit 11a, a rotation unit 12 having a tool bit 30 attached to its distal end portion and being rotated by a drive unit (motor) 17 (see FIG. 3), a main handle 13 that is held in the user's left hand during work, an operation unit (trigger switch) 14 that drives the drive unit 17 (see FIG. 3) according to the amount of operation, a connected portion 15 to which an auxiliary handle 20 is attached, and a battery 18. The interior of the main body 11 also includes a control unit 16, the drive unit 17, a photosensor (rotation detection unit) 19a, and a capacitance sensor (grip detection unit) 19b, as shown in FIG. 3.

The display unit 11a is provided on a side surface of the main body 11, has a built-in light source such as an LED (light emitting diode), and emits light of different colors depending on the result of an operation permission determination for the drive unit 17, which will be described later (discussed below). For instance, a green light is emitted if the operation of the drive unit 17 is permitted, and a red light is emitted if the operation is not permitted.

As shown in FIG. 1, the rotation unit 12 is provided at the distal end of the main body 11 where the tool bit 30 is attached. The rotation unit 12 is rotated by the drive unit 17 (see FIG. 3) to perform various operations according to the attached tool bit 30.

As shown in FIG. 1, the main handle 13 is a user's grip portion provided at the rear of the main body 11 on the opposite side from the tool bit 30, and with the electric gripping tool 10 shown in FIG. 1, it is held in the user's left hand during work.

The operation unit (trigger switch) 14 is provided near the top of the main handle 13 as shown in FIG. 1, and during work this unit is operated by the index finger of the user's left hand while gripping the main handle 13. The operation unit 14 then transmits an operation signal according to the amount of operation to the control unit 16 as shown in FIG. 3. Consequently, the control unit 16 drives the drive unit 17 so as to achieve a rotation speed that matches the amount of operation of the operation unit 14.

As shown in FIG. 2, the connected portion 15 is provided on the right side surface of the main body 11, and the auxiliary handle 20 is attached thereto. The connected portion 15 has an attachment portion 15a.

The attachment portion 15a is provided inside the main body 11, and holds a fixing portion 25 (see FIG. 2, etc.) that is provided on the mounting side of the auxiliary handle 20, in a state in which the fixing portion 25 has been inserted through an insertion hole 15b.

The fixing portion 25 may be held in the attachment portion 15a by, for example, cutting threads around the cylindrical surface of the fixing portion 25 and threading this into the attachment portion 15a.

As shown in FIG. 3, the control unit 16 is connected to the display unit 11a, the communication unit 11b, the operation unit 14, the drive unit 17, the photosensor 19a, and the capacitance sensor 19b. The control unit 16 controls the rotational speed of the drive unit 17 on the basis of the operation amount signal received from the operation unit 14. The control unit 16 also determines whether or not to permit the operation of the drive unit 17 according to the detection results (rotation detection and grip detection) from the photosensor 19a and the capacitance sensor 19b, and transmits the determination result to the manager terminal 50 via the communication unit 11b.

The processing performed by the control unit 16 for determining whether or not the drive unit 17 can be operated will be discussed in detail below.

As shown in FIG. 3, the drive unit 17 is a motor driven by electricity, and applies a rotational drive force to the tool bit 30 (rotation unit 12). Also, the drive unit 17 is rotationally controlled by the control unit 16.

The battery 18 is removably attached to the lower rear end of the main body 11, and supplies power to the display unit 11a, the communication unit 11b, the control unit 16, the drive unit 17, the photosensor 19a, and the capacitance sensor 19b shown in FIG. 3.

The photosensor (rotation detection unit) 19a is provided to detect when the user turns a rotating body 21b provided to the grip portion 21 on the auxiliary handle 20 side (discussed below). The photosensor 19a is provided inside the connected portion 15 where the auxiliary handle 20 is attached to the main body 11. The photosensor 19a is disposed near the position opposite the fixing portion 25 provided on the attachment side of the auxiliary handle 20.

The processing in which the photosensor 19a detects that the user has turned the grip portion 21 of the auxiliary handle 20 will be described in detail below.

The capacitance sensor (grip detection unit) 19b is provided to detect that the user has touched (gripped) a conductive portion (grip input unit) 23 provided so as to be exposed on the surface of the grip portion 21 gripped by the user on the auxiliary handle 20 side (discussed below). The capacitance sensor 19b is provided along with the photosensor 19a inside the connected portion 15 where the auxiliary handle 20 is attached to the main body 11. The capacitance sensor 19b is disposed along with the photosensor 19a near a position opposite the fixing portion 25 provided on the attachment side of the auxiliary handle 20. The capacitance sensor 19b is electrically connected to the conductive portion 23 provided so as to be exposed on the surface of the grip portion 21 of the auxiliary handle 20 (discussed below).

The processing in which the capacitance sensor 19b detects that the user has gripped the grip portion 21 of the auxiliary handle 20 will be described in detail below.

### (2-2) Configuration of Auxiliary Handle 20

The auxiliary handle 20 is gripped in the right hand of the user so that the user can perform work in a stable state, such as when performing work in which the drive unit 17 outputs a high-torque rotational drive force. The auxiliary handle 20 is removably attached to the connected portion 15 provided on the right side surface of the main body 11, as shown in FIG. 2.

The auxiliary handle 20 may be configured to be attached to the left side surface of the main body 11, or to another location such as the upper or lower part, instead of the right side surface of the main body 11 as shown in FIG. 1.

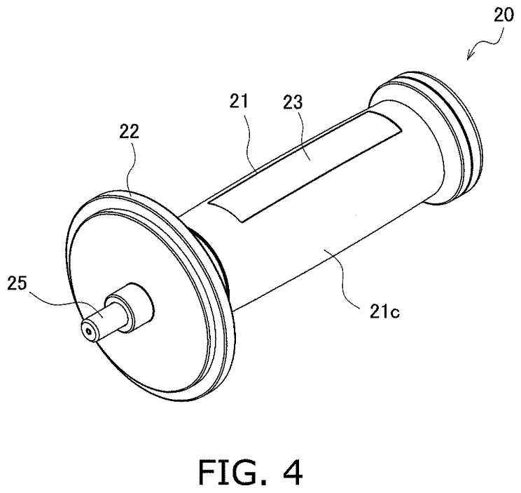

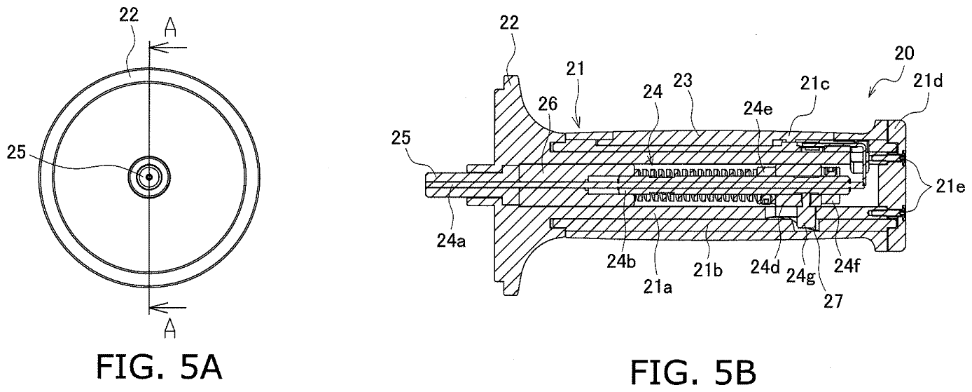

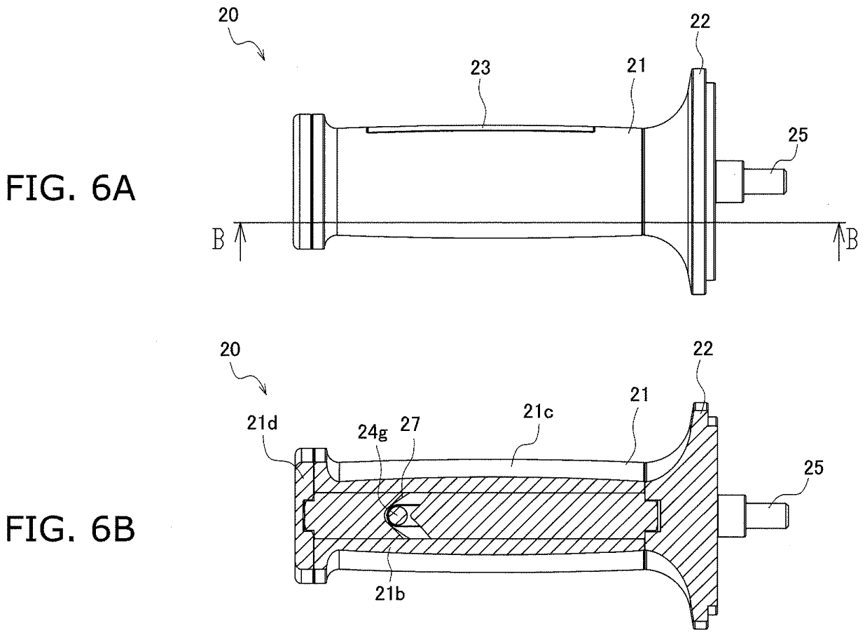

As shown in FIG. 4, the auxiliary handle 20 includes the grip portion 21, the connecting portion 22, the conductive portion 23, and the fixing portion 25. The auxiliary handle 20 also includes in its interior a guide portion 26 and a drive direction conversion mechanism 24 shown in FIGS. 5A and 5B, and a groove portion 27 shown in FIGS. 6A and 6B.

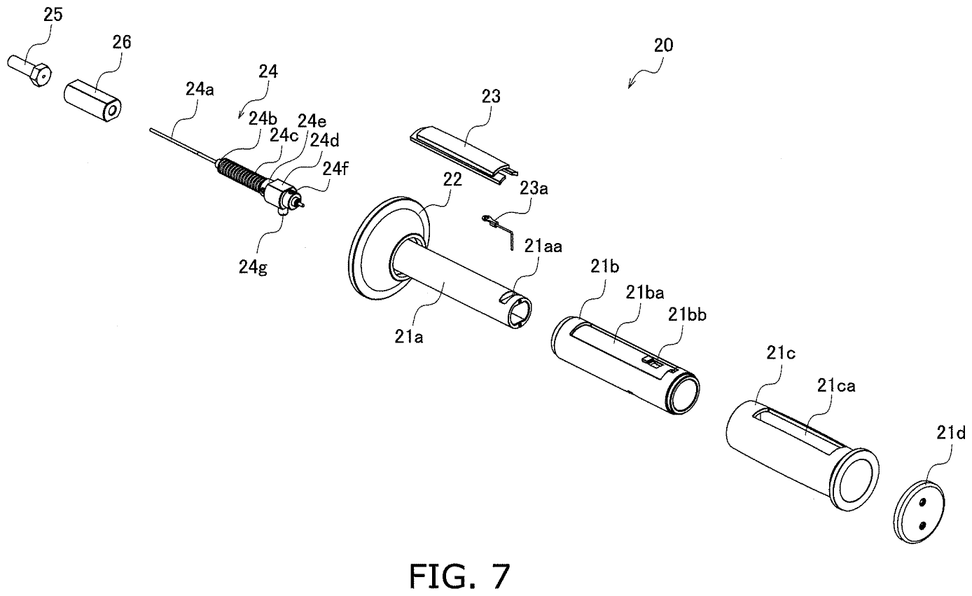

As shown in FIGS. 1 and 2, the grip portion 21 is the part of the auxiliary handle 20 that is gripped in the right hand of the user, and is disposed so as to extend in a direction substantially perpendicular to the right side surface of the main body 11. As shown in FIG. 7, the grip portion 21 has a grip main body 21a, a rotating body (operation input unit) 21b, an insulating tube 21c, a fixed cover 21d, and fixing screws 21e.

As shown in FIG. 7, the grip main body 21a is a substantially cylindrical member connected to the substantially disk-shaped connecting portion 22, and is disposed on the innermost side of the members constituting the grip portion 21. The drive direction conversion mechanism 24 (discussed below) is disposed on the inner peripheral side of the grip main body 21a. The conductive portion 23, a conductive connection wire 23a, a rotating body 21b, an insulating tube 21c, and the like (discussed below) are disposed on the outer peripheral side of the grip main body 21a. As shown in FIG. 7, the grip main body 21a has a through-groove 21aa that allows the outer peripheral surface to communicate with the inner peripheral surface.

The through-groove 21aa is a through-hole provided along the outer peripheral surface at the end of the grip main body 21a, and the distal end of the conductive connection wire 23a (discussed below) is attached in an inserted state. The through-groove 21aa is provided to match the range in which the conductive connection wire 23a moves in response to turning of the rotating body 21b.

The rotating body (operation input unit) 21b is a substantially cylindrical member to which a specific operation (turning) by the user is inputted to the grip portion 21 of the auxiliary handle 20, and is attached in a state of being relatively rotatable with respect to the grip main body 21a. As shown in FIG. 7, the rotating body 21b has an engagement portion 21ba to which the conductive portion 23 (discussed below) is attached, and a through-hole 21bb provided so as to pass through from the outer peripheral surface to the inner peripheral surface of the rotating body 21b.

Here, in the electric gripping tool 10 of this embodiment, the specific operation inputted to the auxiliary handle 20 is a turning operation for rotating the rotating body 21b included in the grip portion 21 toward the side where work is performed by the tool bit 30.

As shown in FIG. 7, the engagement portion 21ba is a recess formed to match the shape of the conductive portion 23, and exposes the conductive portion 23 on the surface of the grip portion 21.

As shown in FIG. 7, the through-hole 21bb is provided at the end of the engagement portion 21ba, and the distal end of the conductive connection wire 23a (discussed below) is attached in an inserted state.

As shown in FIG. 7, the insulating tube 21c is a substantially cylindrical member attached so as to cover the outer periphery of the rotating body 21b, and is attached in a state of being relatively rotatable with respect to the grip main body 21a and in a state of being integrated with the rotating body 21b. The insulating tube 21c has an engagement portion 21ca to which the conductive portion 23 (discussed below) is attached, just like the rotating body.

The engagement portion 21ca is a through-hole formed to match the shape of the conductive portion 23, and exposes the conductive portion 23 attached to the engagement portion 21ba of the rotating body 21b on the surface of the grip portion 21.

As shown in FIG. 7, the fixed cover 21d is a substantially disk-shaped member that closes off the end on the opposite side from the side that attaches to the main body 11, in a state in which the rotating body 21b and insulating tube 21c have been attached to the outer periphery of the grip main body 21a, and is fixed to the gripping main body 21a with the fixing screws 21e.

As shown in FIG. 7, the fixing screws 21e are fastening members for fixing the fixed cover 21d, and fix the fixed cover 21d by being threaded into screw holes provided in the grip main body 21a.

As shown in FIG. 2, the connecting portion 22 is a substantially disk-shaped member that is connected to the connected portion 15 of the main body 11, and has a substantially cylindrical fixing portion 25 protruding from its center portion.

As shown in FIG. 7, the conductive portion (grip input unit) 23 is a conductive member through which the user's grip (contact) of the grip portion 21 of the auxiliary handle 20 is inputted, and is attached to the engagement portion 21ba provided on the outer peripheral surface of the rotating body 21b. That is, the conductive portion 23 is attached in an exposed state on the surface of the grip portion 21, and is held in the right hand when the user grips the grip portion 21 of the auxiliary handle 20. The conductive portion 23 has a conductive connection wire 23a that is electrically connected to the conductive portion 23.

As shown in FIG. 7, the conductive connection wire 23a is electrically connected to the conductive portion 23 and the drive direction conversion mechanism 24 (protruding portion 24a) and is also electrically connected to the capacitance sensor 19b provided on the main body 11 side, and is provided to detect that the user has gripped the grip portion 21 (grasp detection). Also, when the user inputs a turning operation on the rotating body 21b, the conductive connection wire 23a moves within the range of the through-groove 21aa of the grip main body 21a described above.

The drive direction conversion mechanism 24 is a mechanism that converts turning of the auxiliary handle 20 relative to the rotating body 21b into linear movement that causes the protruding portion 24a to protrude relative to the main body 11, and is disposed on the inner peripheral surface side of the grip main body 21a as shown in FIG. 7. That is, the drive direction conversion mechanism 24 converts the force of a turning operation of the auxiliary handle 20 relative to the rotating body 21b to a direction intersecting (perpendicular to) the rotation direction, and causes the protruding portion 24a to move linearly.

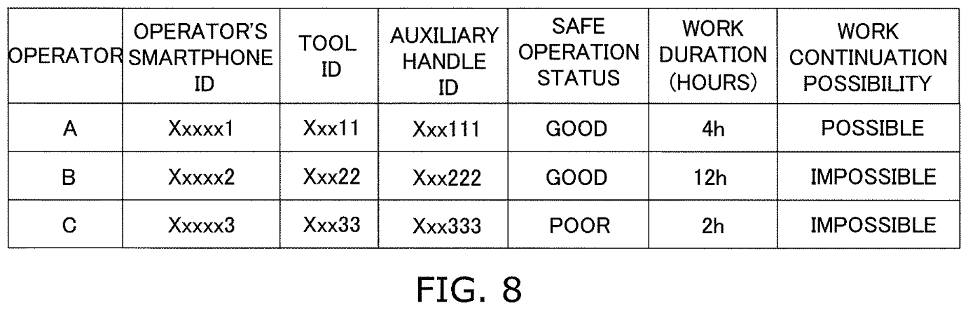

As shown in FIG. 8, the drive direction conversion mechanism 24 has a protruding portion 24a, a cylinder member 24b, a biasing member 24c, a fixing portion 24d, a fixing portion 24e, a fixing portion 24f, and a guide pin (pin) 24g.

The protruding portion 24a is a rod-shaped member that is conductive and is made to protrude toward the main body 11 side by the drive direction conversion mechanism 24 when a turning operation is inputted to the rotating body 21b, and is disposed on the inner peripheral surface side of the grip main body 21a in the initial state before the turning operation is inputted. The protruding portion 24a protrudes from the center portion of the fixing portion 25 (discussed below) in conjunction with the input of the turning operation.

At this point, the protruding portion 24a advances between the light emitting portion and the light receiving portion of the above-mentioned photosensor 19a and hits the capacitance sensor 19b.

Consequently, the photosensor 19a detects the protruding state of the protruding portion 24a, that is, a state in which a turning operation has been inputted, and simultaneously detects that the conductive portion 23 is being touched by the user.

As shown in FIG. 8, the cylinder member 24b is a cylindrical member that envelops the protruding portion 24a, and has a biasing member 24c attached to its outer peripheral surface side.

The biasing member 24c is a coil spring, for example, and is disposed so that a first end on the main body 11 side hits the guide portion 26, and a second end on the opposite side hits the fixing portion 24e (discussed below), as shown in FIG. 5B. The biasing member 24c is disposed along the outer peripheral surface side of the cylinder member 24b, as shown in FIG. 8. When the turning operation of the rotating body 21b of the grip portion 21 of the auxiliary handle 20 is completed, the biasing member 24c applies a biasing force for returning the protruding portion 24a to its initial position. In a state in which no turning operation is being inputted to the rotating body 21b, the biasing member 24c has the length of its initial state, and when a turning operation is inputted, the biasing member 24c contracts in the axial direction of the rotating body 21b (the direction of attachment to the main body 11). Consequently, when the turning operation of the rotating body 21b is completed, the biasing force can return the protruding portion 24a to its initial position.

As shown in FIG. 8, the fixing portion 24d is a substantially cylindrical member, and a guide pin 24g (discussed below) is attached so as to protrude from the outer peripheral surface. The fixing portion 24d is fixed so as not to move relative to the cylinder member 24b by the fixing portions 24e and 24f, which are disposed at the front and rear in the axial direction, to the outer peripheral surface of the cylinder member 24b.

The fixing portions 24e and 24f are disposed so as to sandwich in the axial direction the fixing portion 24d to which the guide pin 24g is attached. The fixing portion 24e is disposed so as to hit one end of the biasing member 24c, and when the rotating body 21b is turned, it presses the biasing member 24c in its contracting direction. The fixing portions 24e and 24f are fixed to the outer peripheral surface of the cylinder member 24b by screws.

The guide pin (pin) 24g is attached to the outer peripheral surface of the above-mentioned substantially cylindrical fixing portion 24d, and is disposed in a state of being engaged with the groove portion 27 (discussed below). When a turning operation is inputted to the rotating body 21b, the guide pin 24g moves along the substantially V-shaped groove portion 27.

Consequently, the guide pin 24g moves in the axial direction toward the main body 11, causing the fixing portion 24d, the cylinder member 24b, and the protruding portion 24a that are integrated with the guide pin 24g to move to the main body 11 side. Therefore, a turning operation of the rotating body 21b can be converted into linear movement in which the protruding portion 24a protrudes to the main body 11 side.

As shown in FIGS. 4 and 5b, the fixing portion 25 is provided so as to protrude from the end face of the connecting portion 22 toward the main body 11, and has a substantially cylindrical shape in which a flange portion is formed at the end, as shown in FIG. 7. The fixing portion 25 has an axial hole in its center into which the protruding portion 24a is inserted.

As shown in FIG. 5B, the guide portion 26 is provided inside the connecting portion 22 in a state of being in contact with the end face of the flange portion of the fixing portion 25, and has a substantially cylindrical shape as shown in FIG. 7. As shown in FIG. 5B, the guide portion 26 is provided so that the end of the biasing member 24c on the main body 11 side hits the guide portion 26. As shown in FIGS. 5B and 7, the guide portion 26 has an axial hole that continues to the axial hole of the fixing portion 25 into which the protruding portion 24a is inserted.

This allows the protruding portion 24a to move back and forth in the axial direction through the axial holes of the fixing portion 25 and the guide portion 26.

As shown in FIG. 6B, the groove portion 27 is a V-shaped groove that is substantially in left and right symmetry, and is provided inside the substantially cylindrical rotating body 21b, and engages with the above-mentioned guide pin 24g. The groove portion 27 is provided so that the lower end of the V shape faces the opposite side (the left side in FIG. 6B) from the side of mounting to the main body 11. When the user grips the grip portion 21 and turns the rotating body 21b together with the insulating tube 21c, the groove portion 27 moves in the peripheral direction of the rotating body 21b, and the guide pin 24g engaged with the groove portion 27 moves along the inclined surface of the V shape. This allows the guide pin 24g to move to the main body 11 side.

That is, in the initial state in which no turning operation has been inputted to the rotating body 21b, the guide pin 24g is engaged with the bottom portion of the V-shaped groove portion 27. When a turning operation is inputted to the rotating body 21b, the V-shaped groove portion 27 rotates, and the guide pin 24g moves along the inclined surface of the V-shaped groove portion 27 so as to be pushed out to the main body 11 side.

Consequently, since the guide pin 24g is integrated with the cylinder member 24b and the protruding portion 24a as discussed above, the protruding portion 24a, etc., can also move to the main body 11 side along with movement of the guide pin 24g.

Here, since the groove portion 27 is V-shaped and in left and right symmetry, even if the user turns the rotating body 21b toward the front, for example, the guide pin 24g can be moved in the direction of causing the protruding portion 24a to protrude.

### Detection of Gripping and Turning of Auxiliary Handle 20

With the electric gripping tool 10 of this embodiment, the gripping and the turning of the auxiliary handle 20 are detected, and the control unit 16 determines whether or not to permit the operation of the drive unit 17.

The detection of the gripping and turning will now be described.

The gripping of the grip portion 21 of the auxiliary handle 20 is detected when the capacitance sensor 19b detects a change in capacitance due to the user's touching of the conductive portion 23, via the conductive connection wire 23a and the protruding portion 24a.

That is, when the user performs a turning operation while gripping the grip portion 21 of the auxiliary handle 20, the above-mentioned drive direction conversion mechanism 24 causes the protruding portion 24a to protrude to the main body 11 side. At this point, the protruding portion 24a is a rod-shaped member that is electrically conductive, and is electrically connected to the conductive portion 23 via the conductive connection wire 23a.

This allows the capacitance sensor 19b to detect a change in capacitance, making it easy to detect a state in which the user is touching the grip portion 21 of the auxiliary handle 20.

The turning of the grip portion 21 of the auxiliary handle 20 is detected when the photosensor 19a provided on the main body 11 side detects the protruding portion 24a that has protruded to the main body 11 side (see FIG. 5B) as a result of the detection that the above-mentioned drive direction conversion mechanism 24 has converted the turning of the rotating body 21b into a linear movement of the protruding portion 24a.

The photosensor 19a has a light emitting portion and a light receiving portion, and detects the protruding portion 24a when the light emitted from the light emitting portion is blocked by the protruding portion 24a, which reduces the amount of light received by the light receiving portion.

This makes it easy to detect whether or not the user has inputted a specific operation (turning) to the grip portion 21 of the auxiliary handle 20.

With the electric gripping tool 10 of this embodiment, when the control unit 16 detects the input of both a gripping operation and a turning operation on the auxiliary handle 20 using the above-mentioned capacitance sensor 19b and photosensor 19a, the operation of the drive unit 17 is permitted when the operation unit 14 is operated.

Consequently, in using the electric gripping tool 10 with the auxiliary handle 20 attached, the operation of the drive unit 17 can be permitted on the condition that not only is the grip portion 21 of the auxiliary handle 20 being touched, but a specific operation (turning operation) is also being performed at the same time.

Therefore, operation of the drive unit 17 is permitted on the condition that the user is touching the grip portion 21 of the auxiliary handle 20 and is performing a specific operation (turning operation), which encourages the user to perform work while firmly gripping the auxiliary handle 20, and further improves user safety.

Also, for example, even if the user affixes a sheet or the like having a high impedance to the conductive portion 23 and attempts to use the electric gripping tool in a state in which the capacitance sensor 19b has mistakenly determined that the user is touching the conductive portion 23, the operation of the drive unit 17 will not be permitted unless the input of a specific operation (turning operation) is detected. Therefore, the electric gripping tool 10 cannot be used until it is deemed that the user is definitely gripping the grip portion 21 of the auxiliary handle 20, and this further improves the safety of the user of the electric gripping tool 10.

In addition, the control unit 16 may have a mode in which the detection result for either the grip detection by the capacitance sensor 19b or the operation detection by the photosensor 19a is deactivated to determine whether or not to permit drive by the drive unit 17.

In this case, when a user works while wearing gloves, for example, the capacitance does not change even when the user grips the grip portion 21 (conductive portion 23), which can make it difficult for the capacitance sensor 19b to detect contact with the grip portion 21. Accordingly, the two conditions for grip detection and operation detection can be relaxed depending on the situation, which makes the electric gripping tool 10 more convenient to use.

Also, with the electric gripping tool 10 of this embodiment, the auxiliary handle 20 has the conductive portion 23 that is electrically connected to the capacitance sensor 19b as a grip input unit, and has a drive mechanism that mechanically drives the protruding portion 24a detected by the photosensor 19a as an operation input portion.

Consequently, the auxiliary handle 20 is provided with a drive mechanism that mechanically drives the grip input unit and the protruding portion 24a detected by the photosensor 19a, by means of the conductive portion 23. This eliminates the need for a power supply unit, a communication unit, etc., on the auxiliary handle 20 side, and allows the auxiliary handle 20 to have a simpler configuration.

Here, when starting to use the electric gripping tool 10 of this embodiment, matching processing is performed between the communication unit 11b of the main body 11, the communication unit 42 of the operator's smartphone 40, and the communication unit 52 of the manager terminal 50.

At this point, as shown in FIG. 8, the manager terminal 50 stores in a storage unit 53 information about each operator's name (A, B, C), the operator's smartphone ID with individual ID (identification), the tool ID, the auxiliary handle ID, the safe operation status, the work duration, and whether or not the work can be continued.

For instance, a record (log) indicating that an operator A has a smartphone with an operator's smartphone ID of Xxxx1, uses a tool with a tool ID of Xxxx11, attaches an auxiliary handle 20 with an auxiliary handle ID of Xxxx111 to the main body 11, and performs work for 4 hours with a safe operation status of “good” is stored in the storage unit 53 of the manager terminal 50. In this case, the possibility of operator A continuing work is determined to be “possible.”

Next, a record (log) indicating that an operator B has a smartphone with an operator's smartphone ID of Xxxx2, uses a tool with a tool ID of Xxx22, attaches an auxiliary handle 20 with an auxiliary handle ID of Xxx222 to the main body 11, and performs work for 12 hours with a safe operation status of “good” is stored in the storage unit 53 of the manager terminal 50. In this case, the possibility of operator B continuing work is determined to be “not possible” because the work duration is too long.

Furthermore, a record (log) indicating that an operator C has a smartphone with an operator's smartphone ID of Xxxx3, uses a tool with a tool ID of Xxxx33, attaches an auxiliary handle 20 with an auxiliary handle ID of Xxx333 to main body 11, and performs work for 2 hours with a safe operation status of “no good” is stored in the storage unit 53 of the manager terminal 50. In this case, the possibility of operator C can continuing work is determined to be “not possible” because the safe operation status is “no good” and the tool was not used properly.

In addition, the manager terminal 50 transmits to the main body 11 and the operator's smartphone 40 a signal indicating the result of the determination as to whether or not work can be performed on the basis of the work status transmitted from the main body 11 of the electric gripping tool 10.

This allows for control such that the electric gripping tool 10 that has received a signal indicating that the operation is “not possible” from the manager terminal 50 is not permitted to operate.

On the other hand, on the operator's smartphone 40 that has received a signal indicating that the work is “not possible,” the display unit 41 is controlled so as to display a message encouraging safe work.

A signal indicating that the operation is “not possible” is sent according to the operator's operation duration or the safe operation status.

### Determination of Whether to Permit Operation of Drive Unit 17 in Electric Gripping Tool 10

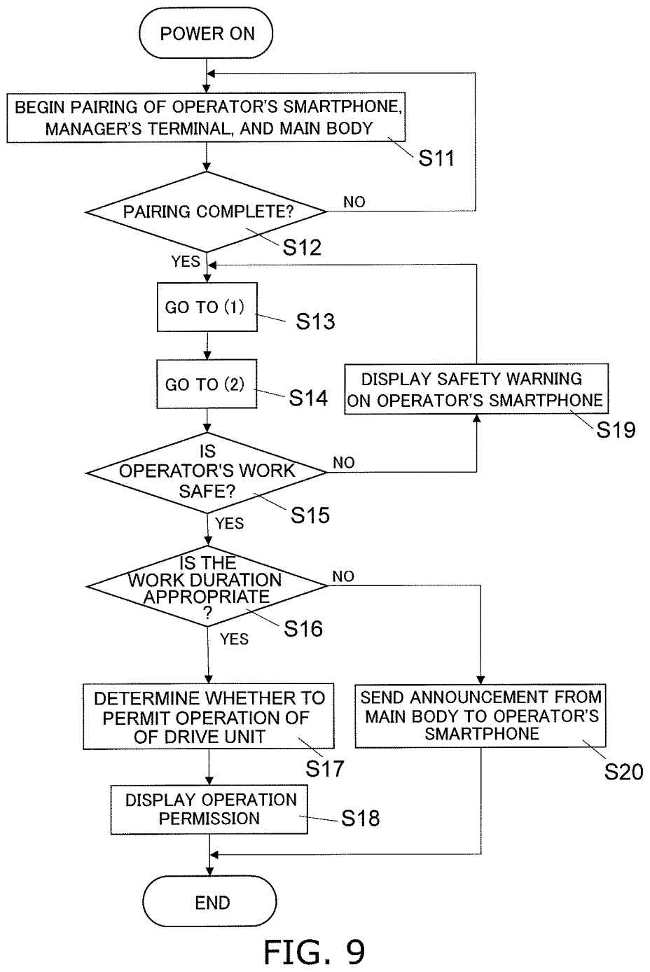

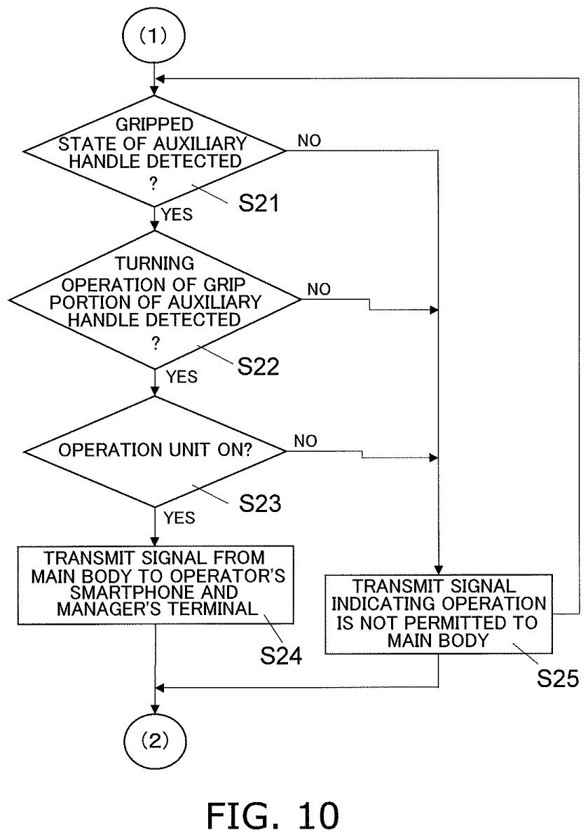

The electric gripping tool 10 in this embodiment is configured as described above, and when work is performed in a state in which the auxiliary handle 20 is attached, control is performed by detecting whether or not the auxiliary handle 20 is being gripped and whether or not a specific operation (turning operation) is being performed. The flow of this operation control processing will now be described with reference to the flowcharts shown in FIGS. 9 and 10.

With the electric gripping tool 10 in this embodiment, as shown in FIG. 9, first, in step S11, pairing is performed between the electric gripping tool 10 (main body 11), the operator's smartphone 40, and the manager terminal 50.

Next, in step S12, it is determined whether or not pairing has been completed. If it is determined that pairing has been completed, the processing proceeds to step S13, but if it is determined that pairing has not been completed, the processing returns to step S11.

Next, in step S13, since it was determined in step S12 that pairing had been completed, the processing proceeds to step S21 in the flowchart shown in FIG. 10.

In step S21, as shown in FIG. 10, the control unit 16 provided on the main body 11 side determines whether or not the capacitance sensor 19b has detected that the user is touching the grip portion 21 (conductive portion 23) of the auxiliary handle 20 (gripped state).

Here, if a gripped state is detected, the processing proceeds to step S22, and otherwise the processing proceeds to step S25.

Next, in step S22, since the gripped state of the grip portion 21 of the auxiliary handle 20 was detected in step S21, the control unit 16 determines whether or not the photosensor 19a has detected a turning operation of the grip portion 21 (rotating body 21b) of the auxiliary handle 20.

If a turning operation has been detected, the processing proceeds to step S23, and otherwise the processing proceeds to step S25.

Next, in step S23, since a gripped state and a turning operation were detected in steps S21 and S22, the control unit 16 determines whether or not the operation unit 14 has been operated.

If the operation unit 14 has been operated, the processing proceeds to step S24, but if the operation unit 14 has not been operated, the processing proceeds to step S25.

Next, in step S24, since a gripped state and turning operation were detected in steps S21 and S22, and it was determined in step S23 that the operation unit 14 was operated, the detection results for the gripped state and turning operation are transmitted from the communication unit 11b on the main body 11 side to the communication unit 42 of the operator's smartphone 40 and the communication unit 52 of the manager terminal 50, and the processing proceeds to step S15 in FIG. 9.

On the other hand, in step S25, since it was determined that a gripped state was not detected in step S21, or that a turning operation was not detected in step S22, or that the operation unit 14 was not operated in step S23, a signal indicating that operation is not permitted is sent from the communication unit 11b on the main body 11 side to the operator's smartphone 40 and the manager terminal 50, and the processing proceeds to step S15 in FIG. 9.

Next, in step S14, the processing proceeds after step S24 or step S25 in the flowchart shown in FIG. 10.

Next, in step S15, in the flowchart shown in FIG. 10, since a gripped state and turning operation were detected, and operation of the operation unit 14 was detected, the control unit 16 of the main body 11 determines whether or not the operator's work is safe.

Here, if the control unit 16 receives signals indicating a gripped state and turning operation from the auxiliary handle 20 and the detection results of the operation of the operation unit 14, and determines that the work being done by the operator is safe, the processing proceeds to step S16. On the other hand, if the control unit 16 determines that the work being done by the operator is not safe and operation is not permitted, the processing proceeds to step S19.

Next, in step S16, the control unit 16 of the main body 11 determines whether the operator work has been using the electric gripping tool 10 for the proper amount of time.

If the control unit 16 determines that the work duration is within the proper range, the processing proceeds to step S17. On the other hand, if the control unit 16 determines that the work duration is not within the proper range, the processing proceeds to step S20.

Next, in step S17, since in step S15 the control unit 16 of the main body 11 determined that the work being done by the operator is safe and in step S16 the work duration is proper, it is determined that operation of the drive unit 17 is permitted, and the drive unit 17 becomes able to operate and work can be performed.

Next, in step S18, upon receiving the operation permission determination, the control unit 16 controls the display unit 11a to display that operation is permitted (such as by turning on a green light), and the processing is then ended.

On the other hand, in step S19, because it was determined in step S15 that the work being done by the operator was unsafe, the communication unit 11b of the main body 11 sends a signal to the operator's smartphone 40 owned by the operator instructing it to display a safety warning on the display unit 41, the processing returns to step S13, and the transition processing is repeated.

Also, in step S20, since it was determined in step S16 that the operator's work duration was not within the proper range, a signal is sent (announced) from the communication unit 11b of the main body 11 to the operator's smartphone 40 owned by the operator, instructing it to display a message on the display unit 41 indicating that the work duration is outside the proper range, etc., and processing is ended.

### Main Features

As shown in FIG. 3, the manager terminal 50 of the electric gripping tool 10 in this embodiment is a usage status management apparatus that manages the usage status of the electric gripping tool 10, and includes the communication unit 52 and the storage unit 53. The communication unit 52 acquires from the electric gripping tool 10 information about the usage status of the electric gripping tool 10, such as the work duration and the safe operation status of each user. The storage unit 53 stores the information related to the usage status acquired by the communication unit 52.

This allows the manager terminal 50 to acquire and manage information related to each user's work duration and whether the operation is being performed safely, making it possible to take measures such as sending a message to users urging them to stop working or operate more safely.

As a result, it is possible to appropriately manage whether the electric gripping tool 10 is being used safely and properly.

### Embodiment 2

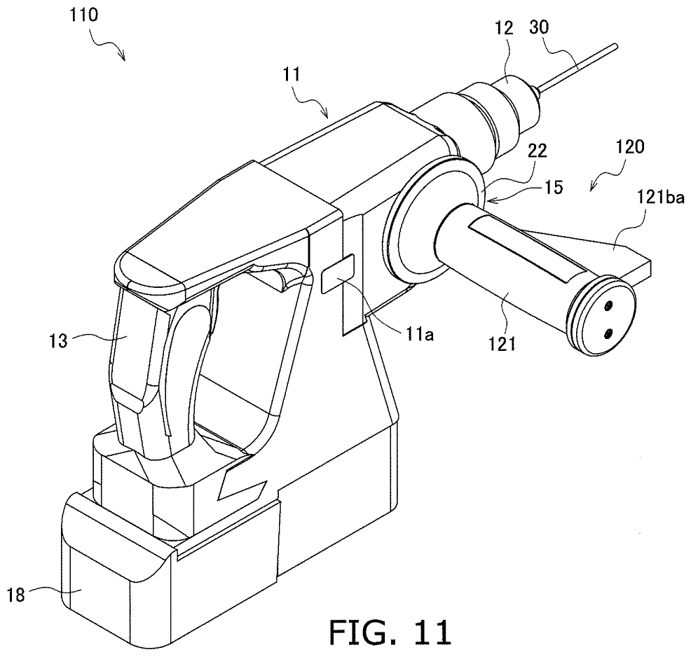

An electric gripping tool 110 according to another embodiment of the present invention will now be described with reference to FIGS. 11 to 13.

As shown in FIG. 11, the electric gripping tool 110 in this embodiment detects the operation of pressing a lever (operation input unit) 121ba provided to an auxiliary handle 120 as a specific operation, which differs from the configuration of the Embodiment 1 above, in which the turning of the rotating body 21b is detected as the specific operation.

In the configuration of this embodiment, components having the same functions and shapes as those described in Embodiment 1 above are numbered the same, and will not be described again in detail.

As shown in FIG. 11, with the electric gripping tool 110 in this embodiment, the auxiliary handle 120 including a grip portion 121 having the lever 121ba is removably attached to a side surface of the main body 11.

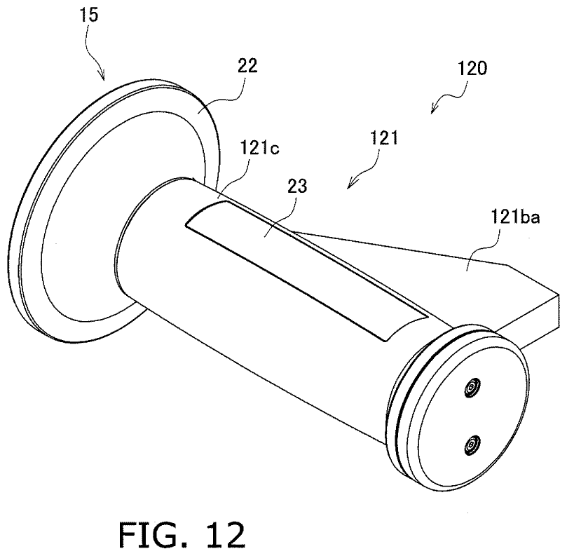

As shown in FIG. 12, the auxiliary handle 120 has the lever 121ba provided so as to protrude from the outer peripheral surface of the grip portion 121.

When the user grasps the grip portion 121, the lever 121ba is pushed inward in the radial direction of the grip portion 121, and the drive direction is converted by the drive direction conversion mechanism 24 described in Embodiment 1 above, causing the protruding portion 24a to protrude to the main body 11 side.

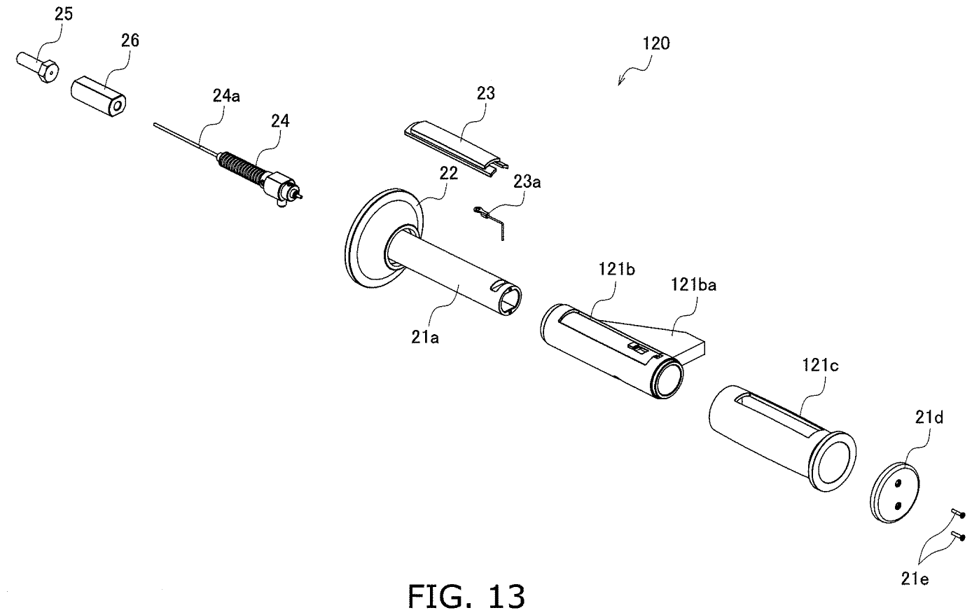

As shown in FIG. 13, the lever 121ba is provided to a cylindrical portion 121b and is provided so as to protrude through a through-groove provided to an insulating cylinder 121c.

Consequently, the control unit 16 can permit the drive unit 17 to be driven on the condition that the user is not only touching the auxiliary handle 120 but also performing a specific operation (lever operation) on the auxiliary handle 120, thereby permitting the drive unit 17 to be driven, after confirming that the operator is presumably gripping the auxiliary handle 120 firmly.

As a result, when working in a state in which the auxiliary handle 120 is attached to the main body 11, the safety of the operator is further improved, and the safe use of the electric gripping tool 110 can be managed at the manager terminal 50.

### Embodiment 3

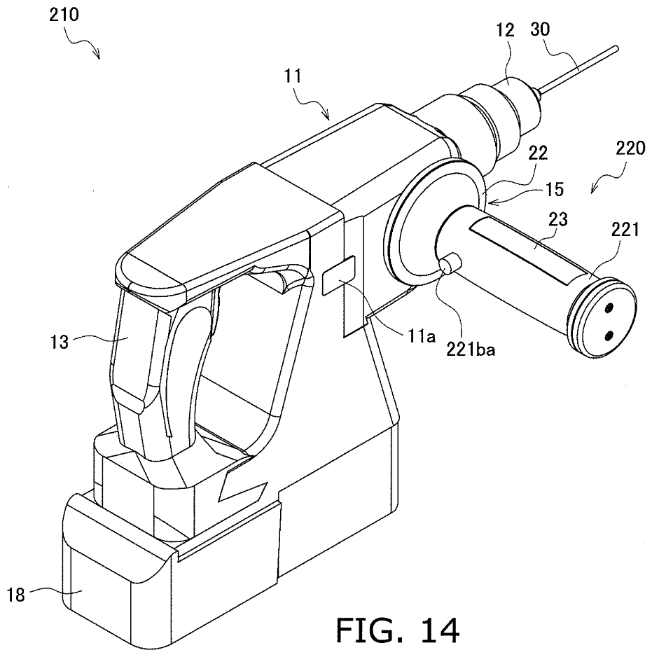

An electric gripping tool 210 according to yet another embodiment of the present invention will now be described with reference to FIGS. 14 to 16.

As shown in FIG. 14, the electric gripping tool 210 in this embodiment detects the operation of pressing a button (operation input unit) 221ba provided on the auxiliary handle 220 as a specific operation, which differs from the configuration of Embodiment 1 above, in which the turning of the rotating body 21b is detected as the specific operation.

In the configuration of this embodiment, components having the same function and shape as those described in Embodiment 1 above are numbered the same, and will not be described in detail again.

As shown in FIG. 14, in the electric gripping tool 210 of this embodiment, an auxiliary handle 220 including a grip portion 221 having a button 221ba is removably attached to a side surface of the main body 11.

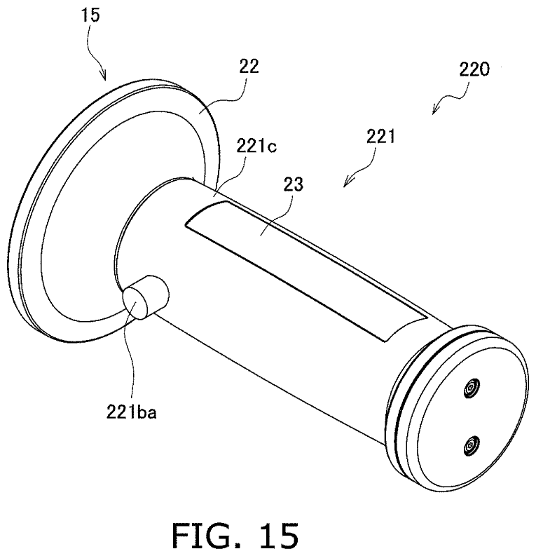

As shown in FIG. 15, the auxiliary handle 220 has the button 221ba provided so as to protrude from the outer peripheral surface of the grip portion 221.

When the user grasps the grip portion 221, the button 221ba is pushed inward in the radial direction of the grip portion 221, whereby the drive direction is converted by the drive direction conversion mechanism 24 described in Embodiment 1 above, and the protruding portion 24a protrudes to the main body 11 side.

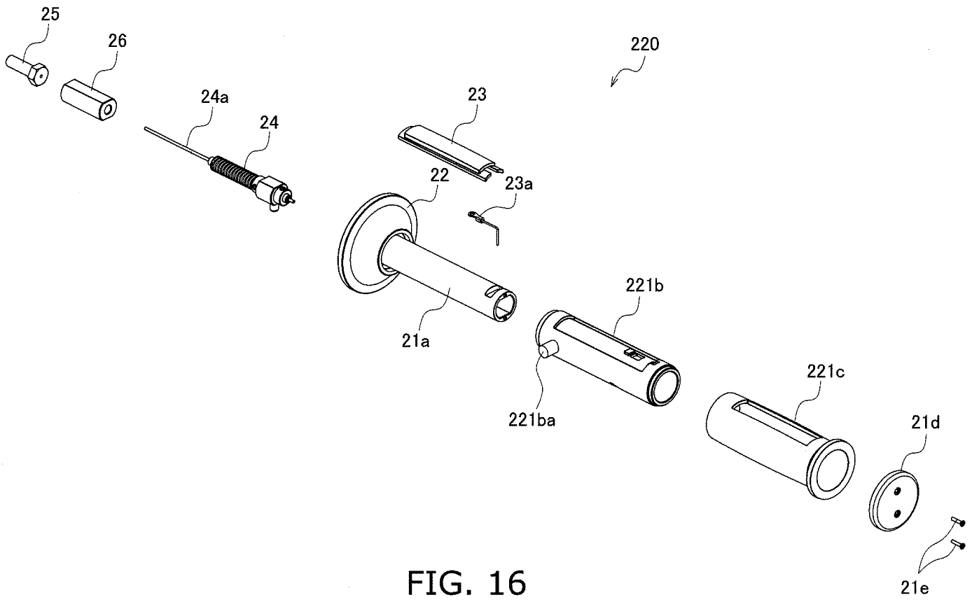

As shown in FIG. 16, the button 221ba is provided on the cylindrical portion 221b so as to protrude through a through-hole provided in the insulating cylinder 221c.

Consequently, the control unit 16 can permit the drive unit 17 to be driven only on the condition that the user is not only touching the auxiliary handle 220 but also performing a specific operation (button operation) on the auxiliary handle 220, and can permit the drive unit 17 to be driven only after confirming that the operator is presumably gripping the auxiliary handle 220 firmly.

As a result, when working in a state in which the auxiliary handle 220 is attached to the main body 11, the safety of the operator is further improved, and the safe use of the electric gripping tool 210 can be managed at the manager terminal 50.

### Embodiment 4

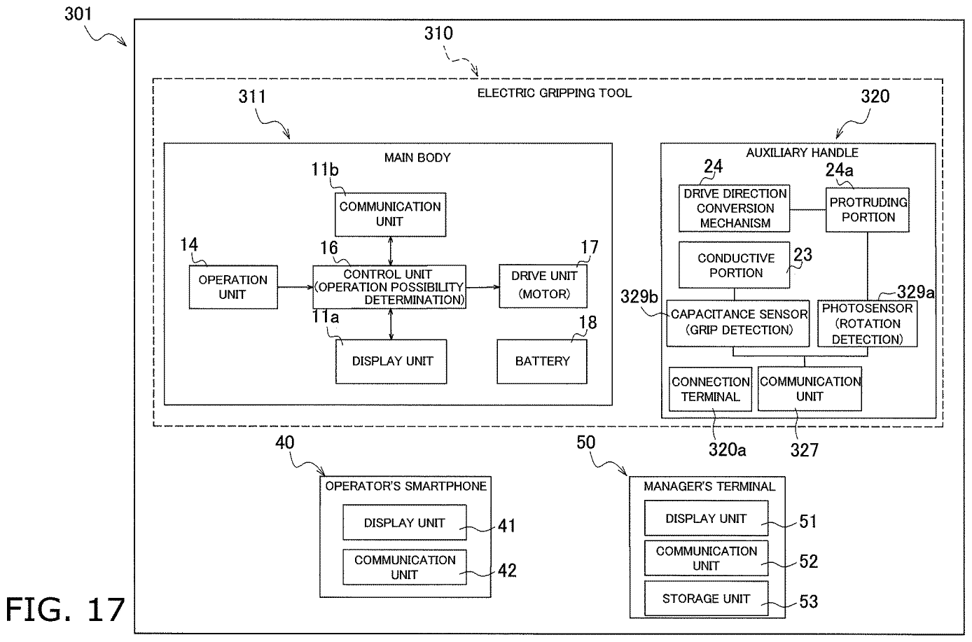

An electric gripping tool 310 according to yet another embodiment of the present invention will now be described with reference to FIG. 17.

The electric gripping tool 310 of this embodiment differs from the configuration of Embodiment 1 above in that, as shown in FIG. 17, the electric gripping tool 310 is provided with a connection terminal 320a, a communication unit 327, a photosensor 329a, and a capacitance sensor 329b on the auxiliary handle 320 side.

In the configuration of this embodiment, components having the same functions and shapes as those described in Embodiment 1 above are numbered the same, and will not be described again in detail.

With the electric gripping tool 310 of this embodiment, as shown in FIG. 17, power is supplied from the battery 18 provided on the main body 311 side via the connection terminal 320a to drive the communication unit 327, the photosensor 329a, and the capacitance sensor 329b.

The detection results for the specific operation (turning operation, etc.) and the gripped state detected by the photosensor 329a and the capacitance sensor 329b are transmitted via the communication unit 327 to the main body 311, the operator's smartphone 40, and the manager terminal 50.

Consequently, just as in Embodiment 1 above, the manager terminal 50 can acquire and manage information related to each user's work duration and whether safe operations are being performed, and measures can be taken such as sending messages to users urging them to stop working or to operate safely.

As a result, a usage status management system 301 can be provided that can appropriately manage whether the electric gripping tool 310 is being used safely and properly.

### Other Embodiments

Embodiments of the present invention were described above, but the present invention is not limited to or by the above embodiments, and various modifications are possible without departing from the gist of the invention.

(A)

In the above embodiments, an example was given in which, when the electric gripping tool 10 was used with the auxiliary handle 20 attached, it was determined whether or not the electric gripping tool 10 was being used safely, including the auxiliary handle 20, and the safe use status for each user was managed by the manager terminal 50. However, the present invention is not limited to this.

For example, the configuration may be such that it is determined whether or not an electric gripping tool without an auxiliary handle is being used safely, and a usage status management apparatus such as an manager terminal manages the safe usage status for each user.

(B)

In the above embodiments, an example was given in which the usage status management apparatus was the manager terminal 50 installed in a management company or the like that managed users of the electric gripping tool 10. However, the present invention is not limited to this.

For example, a user terminal such as a smartphone or tablet terminal owned by each user may be used as the usage status management apparatus.

(C)

In the above embodiments, an example was given in which the capacitance sensor 19b was used as a grip detection unit. However the present invention is not limited to this.

For example, the grip detection unit may be configured using some other means, such as a piezoelectric element.

Here again, the same effect as above can be obtained by using a piezoelectric element or the like to detect that the user has grasped the grip portion of the auxiliary handle.

(D)

In the above embodiments, an example was given in which the photosensor 19a was used as an operation detection unit. However the present invention is not limited to this.

For example, the operation detection unit may be configured using some other means, such as a piezoelectric element, a magnetic sensor, a contact sensor, or a capacitance sensor.

Here again, the same effect as above can be obtained by using a piezoelectric element, a magnetic sensor, a contact sensor, a capacitance sensor, or the like to detect a protruding portion that moves in response to a specific operation of the auxiliary handle by the user.

(E)

In the above embodiments, an example was given in which the display unit 11a displayed whether or not a tool could be used by changing the color of the light of an LED or the like. However, the present invention is not limited to this.

For example, the display unit may be a liquid crystal display panel that displays the usability status.

(F)

In the above embodiments, an example was given in which the electric gripping tool 10 was one in which the user held the auxiliary handle 20 with his right hand and the main handle 13 with his left hand. However, the present invention is not limited to this.

For example, the electric gripping tool may be one in which the auxiliary handle is attached to the opposite side of the main body so that the auxiliary handle is held in the user's left hand and the main handle in the user's right hand.

(G)

In the above embodiments, an example was given in which a trigger switch that adjusted the output torque of the drive unit (motor) 17 according to the pulling amount (operation amount) was used as the operation unit for driving the drive unit (motor) 17 of the electric gripping tool 10. However, the present invention is not limited to this.

For example, instead of a trigger switch, some other switch such as an on/off switch may be used.

(H)

In the above embodiments, an example was given in which the electric gripping tool 10 was equipped with a motor driven by electricity, but the present invention is not limited to this.

For example, the present invention may be applied to a power tool in which a drive unit is operated by air instead of electricity.

(I)

In the above embodiments, an example was given in which the present invention was applied to the electric gripping tool 10 such as an electric screwdriver, as an example of the power tool according to the present invention. However, the present invention is not limited to this.

For example, the present invention may be applied to power tools for performing various kinds of work, such as grinders, jigsaws, chainsaws, etc., in addition to electric screwdrivers.

### INDUSTRIAL APPLICABILITY

The electric gripping tool usage status management apparatus of the present invention exhibits the effect that whether or not an electric gripping tool is being used safely and properly can be properly managed, and as such is widely applicable to various systems that include an electric gripping tool.

### REFERENCE SIGNS LIST

1 usage status management system
10 electric gripping tool
11 main body
11a display unit
11b communication unit
12 rotation unit
13 main handle
14 operation unit (trigger switch)
15 connected portion
15a attachment portion
15b insertion hole
16 control unit
17 drive unit
18 battery (power supply)
19a photosensor (operation detection unit)
19b capacitance sensor (grip detection unit)
20 auxiliary handle
21 grip portion
21a grip main body
21aa through-groove
21b rotating body (operation input unit)
21ba engagement portion
21bb through-hole
21c insulating tube
21ca engagement portion
21d fixed cover
21e fixing screw
22 connecting portion
23 conductive portion (grip input unit)
23a conductive connection wire
24 drive direction conversion mechanism
24a protruding portion
24b cylinder member
24c biasing member
24d fixing portion
24e fixing portion
24f fixing portion
24g guide pin (pin)
25 fixing portion
26 guide portion
27 groove portion
30 tool bit
40 operator's smartphone (operator's terminal)
41 display unit
42 communication unit
50 manager terminal (usage status management apparatus)
51 display unit
52 communication unit (usage status acquisition unit)
53 storage unit
110 electric gripping tool
120 auxiliary handle
121 grip portion
121b cylindrical portion
121ba lever (operation input unit)
121c insulating tube
210 electric gripping tool
220 auxiliary handle
221 grip portion
221b cylindrical portion
221ba button (operation input unit)
221c insulating tube
301 usage status management system
310 electric gripping tool
311 main body
320 auxiliary handle
320a connection terminal
327 communication unit
329a photosensor (rotation detection unit)
329b capacitive sensor (grip detection unit)

1. A usage status management apparatus for managing a usage status of an electric gripping tool, the usage status management apparatus comprising:
a usage status acquisition unit configured to acquire, from the electric gripping tool, information about a work duration and safe operation status of each user as information related to a usage status of the electric gripping tool; and
a storage unit configured to store information related to the usage status acquired by the usage status acquisition unit.

2. The usage status management apparatus for an electric gripping tool according to claim 1,
wherein the electric gripping tool is used in a state in which an auxiliary handle has been mounted, and
the usage status includes a result of detecting a user's gripped state of the auxiliary handle and an input of a specific operation.

3. The usage status management apparatus for an electric gripping tool according to claim 2,
wherein the specific operation includes an operation of rotating a grip portion of the auxiliary handle.

4. The usage status management apparatus for an electric gripping tool according to claim 2,
wherein the specific operation includes an operation of pressing a lever portion provided to the auxiliary handle.

5. The usage status management apparatus for an electric gripping tool according to claim 2,
wherein the specific operation includes an operation of pressing a button portion provided to the auxiliary handle.

6. The usage status management apparatus for an electric gripping tool according to claim 1,
wherein the usage status acquisition unit communicates with an operator terminal owned by each user of the electric gripping tool.

7. The usage status management apparatus for an electric gripping tool according to claim 1,
wherein the usage status includes a determination result related to whether the electric gripping tool is usable, as determined in the electric gripping tool.

8. The usage status management apparatus for an electric gripping tool according to claim 1,
wherein the usage status includes unique ID information assigned to each electric gripping tool.

9. The usage status management apparatus for an electric gripping tool according to claim 2,
wherein the usage status includes unique ID information assigned to each auxiliary handle.

10. The usage status management apparatus for an electric gripping tool according to claim 6,
wherein the usage status includes unique ID information assigned to each of the operator terminals.

11. The usage status management apparatus for an electric gripping tool according to claim 1,
further comprising a display unit configured to display the usage status of the electric gripping tool for each user, which is stored in the storage unit.

12. The usage status management apparatus for an electric gripping tool according to claim 2,
wherein the usage status acquisition unit communicates with a communication unit provided to the auxiliary handle.

13. A usage status management system for an electric gripping tool, comprising:
the usage status management apparatus for an electric gripping tool according to claim 1; and
the electric gripping tool.
